(19) United States
(12) Patent Application Publication
(10) Pub. No.: US 2011/0052823 A1
(43) Pub. Date: Mar. 3, 2011

(54) AQUEOUS COATING MATERIAL, A METHOD FOR THE PRODUCTION THEREOF AND THE USE THEREOF

(75) Inventors: Bernhard Steinmetz, Rutschenhausen (DE); Nadia Emmerich, Karlstadt-Stetten (DE); Matthias Wetterich, Grettstadt (DE)

(73) Assignee: BASF COATINGS GMBH, Münster (DE)

(21) Appl. No.: 12/919,564

(22) PCT Filed: Feb. 12, 2009
(86) PCT No.: PCT/EP09/00982

§ 371 Date: Nov. 5, 2010

(30) Foreign Application Priority Data
Feb. 12, 2008 (DE) 10 2008 008 779.3

(51) Int. Cl. C09D 175/04; B05D 1/36

(52) U.S. Cl. 427/407.1; 524/590

(57) ABSTRACT

An aqueous coating material comprising at least one ionically and/or nonionically stabilized polyurethane, which is saturated, unsaturated and/or grafted with olefinically unsaturated compounds, wherein said coating material contains between 0.5% and 30% by weight of polytetrahydrofuran, based on the total weight of the coating material.

### FIELD OF THE INVENTION

The present invention relates to a new aqueous coating material comprising at least one ionically and/or nonionically stabilized polyurethane which is saturated, unsaturated and/or grafted with olefinically unsaturated compounds. Additionally the present invention relates to a new process for preparing an aqueous coating material. The present invention further relates to the use of the new coating material and of the aqueous coating material prepared by the new process.

### PRIOR ART

Aqueous coating materials comprising at least one ionically and/or nonionically stabilized polyurethane which is saturated, unsaturated and/or grafted with olefinically unsaturated compounds are known. They may be cured physically, thermally, or both thermally and with actinic radiation. Preferably they comprise color and/or effect pigments and are used for producing color and/or effect paint coats, more particularly as solid-color topcoats or basecoats as part of multicoat paint systems.

In the original production-line finishing (OEM) of automobile bodies, the bodies are typically first subjected to cathodic electrodeposition coating and to coating with primer-surfacer. After a variety of polishing and grinding operations, a topcoat material, composed for example of a solid-color topcoat material or of a basecoat and a clearcoat material, is applied. Any grinding scars that may have remained from the polishing and grinding operations must be concealed by the topcoat, since otherwise they are visible in the completed finish and mean that the corresponding bodies must be painted once again, which entails great financial cost. Many solid-color topcoat materials and basecoat materials exhibit the problem of inadequate grind mark concealment.

A person skilled in the art is currently aware of the following methods of avoiding this defect pattern:
raising the hiding power of the basecoat material or solid-color topcoat material,
altering the wettability of the basecoat material or solid-color topcoat material on the substrate,
incorporating fillers into the basecoat material or solid-color topcoat material for the purposes of reducing or preventing the defect pattern.

It is unknown to date to use polytetrahydrofurans as binders in aqueous basecoat materials.

Japanese laid-open specification JP 2005-220288 A describes a conventional solventborne metallic basecoat material for use in OEM paint systems, it being possible for said material to comprise, among other components, polyetherpolyols, including polytetrahydrofurans, in order to improve the flop effect and the delamination resistance of the coating. A problem addressed by JP 2004-31672 is that of providing a metallic basecoat material with little shade fluctuation, high transparency, good gloss properties, and good flop effect. The binder composition of the basecoat material that is required for this purpose is defined in detail in JP 2004-31672.

Japanese patent application JP 1985-212063 describes the use of polytetrahydrofuran in water-resistant coatings for use as masonry paints. The advantage of these paints lies in the high water resistance of the coatings.

### Problem Addressed by the Invention

The problem on which the present invention is based is that of providing a new aqueous coating material, comprising at least one ionically and/or nonionically stabilized polyurethane, saturated, unsaturated and/or grafted with olefinically unsaturated compounds, said material being easy to prepare and exhibiting improved grind mark concealment after spray application.

The new aqueous coating material ought more particularly to be suitable as an aqueous basecoat material for producing color and/or effect basecoats of multicoat paint systems by the wet-on-wet method.

The new aqueous coating material is intended to yield coatings, preferably color and/or effect coatings, more preferably basecoats and solid-color topcoats, more particularly basecoats in multicoat paint systems, which after spray application have hardly any remaining grind marks.

### Solution Provided by the Invention

The problems identified above are solved by a new coating material of the type specified at the outset wherein said coating material contains between 0.5% and 30% by weight of polytetrahydrofuran, based on the total weight of the coating material.

Also found has been a new process for preparing an aqueous coating material of the invention, which comprises dispersing at least one ionically and/or nonionically stabilized polyurethane which is saturated, unsaturated and/or grafted with olefinically unsaturated compounds, and between 0.5% and 30% by weight of polytetrahydrofuran, based on the total weight of the coating material, in an aqueous medium.

Found not least has been the new use of the coating material of the invention, and of the coating material prepared by the process of the invention, for producing multicoat color and/or effect paint systems, this being referred to below as “inventive use”.

Additional subject matter of the invention will become apparent from the claims and from the description which now follows.

### ADVANTAGES OF THE INVENTION

In light of the prior art it is surprising and was unforeseeable for the skilled worker that the problem on which the present invention is based is solved by means of the coating material of the invention, the process of the invention, and the inventive use.

A particular surprise is that the coating material of the invention is simple to prepare, no longer includes any toxicologically objectionable ingredients, and following spray application exhibits no—or very few—grind marks.

Surprisingly the coating material of the invention can be used in the context of the inventive use as an aqueous basecoat material for producing color and/or effect basecoats of multicoat paint systems by the wet-on-wet method. In this application the coating exhibits very few, if any, grind marks.

In the context of the inventive use, the coating material of the invention yields coatings of the invention, preferably color and/or effect coatings, more preferably basecoats and solid-color topcoats, more particularly basecoats in multicoat paint systems, which exhibit very few, if any, grind marks. Furthermore, the coatings have a particularly high hiding power and an outstanding overall visual appearance. The coating material of the invention is therefore outstandingly suitable for the finishing of automobile bodies.

### DETAILED DESCRIPTION OF THE INVENTION

The first key constituent of the coating material of the invention is at least one ionically and/or nonionically stabilized polyurethane which is saturated, unsaturated and/or grafted with olefinically unsaturated compounds and is preferably based on aliphatic, cycloaliphatic, aliphatic-cycloaliphatic, aromatic, aliphatic-aromatic and/or cycloaliphatic-aromatic polyisocyanates. For stabilization the polyurethane contains alternatively
functional groups which can be converted by neutralizing agents and/or quaternizing agents into cations, and/or cationic groups, or
functional groups which can be converted by neutralizing agents into anions, and/or anionic groups, and/or
nonionic hydrophilic groups.

Suitable polyurethanes are known for example from
German patent application DE 199 11 498 A1, column 1 lines 29 to 49 and column 4 line 23 to column 11 line 5,
German patent application DE 199 48 004 A1, page 4 line 19 to page 13 line 48,
European patent application EP 0 228 003 A1, page 3 line 24 to page 5 line 40,
European patent application EP 0 634 431 A1, page 3 line 38 to page 8 line 9, or
international patent application WO 92/15405, page 2 line 35 to page 10 line 32.

In the coating material of the invention they are present in the typical and known amounts.

Where the coating material of the invention is curable physically, thermally with self-crosslinking, or thermally with self-crosslinking and with actinic radiation, its polyurethane content is preferably 50% to 100%, more preferably 50% to 90%, and more particularly 50% to 80% by weight, based in each case on the film-forming solids of the coating material of the invention.

Where the coating material of the invention is curable thermally with external crosslinking, or thermally with external crosslinking and with actinic radiation, its polyurethane content is preferably 10% to 80%, more preferably 15% to 75%, and more particularly 20% to 70% by weight, based in each case on the film-forming solids of the coating material of the invention.

The coating material of the invention is curable physically, thermally, or both thermally and with actinic radiation. The thermal cure, or both thermal and actinic radiation cure, may be assisted by the physical curing.

For the purposes of the present invention the term “physical curing” means the curing of a layer of a coating material by filming, where appropriate after drying of the layer. Typically no crosslinking agents are necessary for this cure. Where appropriate the physical curing may be assisted by atmospheric oxygen or by exposure to actinic radiation.

For the purposes of the present invention the term “thermal curing” denotes the heat-initiated curing of a layer of a coating material where typically a separate crosslinking agent is employed. The crosslinking agent comprises reactive functional groups which are complementary to the reactive functional groups present in the polyurethanes. This is typically referred to by those in the art as external crosslinking. Where the complementary reactive functional groups or autoreactive functional groups, i.e., groups which react “with themselves”, are already present in the polyurethanes, the latter are self-crosslinking. Examples of suitable complementary reactive functional groups and autoreactive functional groups are known from German patent application DE 199 30 665 A1, page 7 line 20 to page 9 line 8.

Actinic radiation for the purposes of the present invention means electromagnetic radiation such as near infrared (NIR), visible light, UV radiation, X-rays or gamma radiation, more particularly UV radiation, and particulate radiation such as electron beams, beta radiation, alpha radiation, proton beams or neutron beams, more particularly electron beams. Curing by UV radiation is typically initiated by free-radical or cationic photoinitiators.

Where thermal curing and curing with actinic light are employed jointly in the context of a coating material of the invention, another term used is “dual cure”.

The coating material of the invention may be a one-component (1K) system.

For the purposes of the present invention a one-component (1K) system may be a thermosetting coating material in which the binder and the crosslinking agent are present alongside one another, i.e., in one component. A prerequisite for this is that the two constituents crosslink with one another only at relatively high temperatures and/or on exposure to actinic radiation.

The coating material of the invention may further be a two-component (2K) or multicomponent (3K, 4K) system.

For the purposes of the present invention this means a coating material in which more particularly the binder and the crosslinking agent are present separately from one another in at least two components, which are only combined a short time before application. This form is chosen when binder and crosslinking agent react with one another even at room temperature. Coating materials of this kind are employed primarily in the coating of thermally sensitive substrates, more particularly in automotive refinish.

The second key constituent of the coating material of the invention is polytetrahydrofuran.

It is preferred to use polytetrahydrofurans which have a number-average molar mass of 250-10 000. Used with particular preference are polytetrahydrofurans which have a number-average molar mass of 250-2000.

Polytetrahydrofurans are typical and known products which are obtainable commercially. For example, they are sold under the brand name PoIyTHF® by BASF AG.

The amount of polytetrahydrofuran in the coating material of the invention may vary widely and in this way may be tailored to the requirements of the case in hand. In light of the cost of polytetrahydrofuran, however, there is concern to minimize its content. In this context it is a particular advantage that a polytetrahydrofuran content for the coating material of the invention of 0.5% to 30%, preferably 0.5% to 20%, and more particularly 1% to 15% by weight, based in each case on the coating material of the invention, is sufficient to obtain the advantageous technical effects of the invention.

The coating material of the invention may further comprise at least one additive. Preferably it comprises at least two additives. The additive is preferably selected from the group of the additives that are typically used in the field of coating materials. With particular preference the additive is selected from the group consisting of salts which can be decomposed thermally without residue or substantially without residue, binders, other than the polyurethanes, which are curable physically, thermally and/or with actinic radiation, crosslinking agents, organic solvents, thermally curable reactive diluents, reactive diluents curable with actinic radiation, color and/or effect pigments, transparent pigments, fillers, molecularly dispersely soluble dyes, nanoparticles, light stabilizers, antioxidants, devolatilizers, emulsifiers, slip additives, polymerization inhibitors, free-radical polymerization initiators, thermolabile free-radical initiators, adhesion promoters, flow control agents, film-forming assistants, thickeners, rheological assistants, flame retardants, corrosion inhibitors, free-flow aids, waxes, siccatives, biocides, and matting agents.

Suitable additives of the aforementioned kind are known for example from
German patent application DE 199 48 004 A1, page 14 line 4 to page 17 line 5,
German patent application DE 199 11 498 A1, column 11 line 9 to column 15 line 63, or
German patent DE 100 43 405 C1, column 5, paragraphs [0031] to [0033].

They are used in the typical and known effective amounts.

The solids content of the coating material of the invention may vary very widely and can therefore be tailored to the requirements of the case in hand. The solids content is guided primarily by the viscosity necessary for application, more particularly spray application, and so the solids content can be adjusted by the skilled worker on the basis of his or her general art knowledge, with the assistance where appropriate of a few rangefinding tests. The solids content is determined as the nonvolatile mass fraction after drying at 120° C. for 60 minutes. Preferably the solids content is 5% to 70%, more preferably 10% to 65%, and more particularly 15% to 60% by weight, based in each case on the coating material of the invention.

The coating material of the invention is preferably prepared by means of the process of the invention. In that case the constituents described above are dispersed in an aqueous medium, more particularly in water, preferably with addition of a wetting agent or dispersant. Preferably then the resulting mixture is homogenized.

A suitable aqueous medium is, for example, water or a medium which in addition to water comprises one or more organic solvents.

As wetting agents or dispersants it is possible for example to use surfactants, polyethylene oxides or polypropylene oxides.

Viewed in terms of its method, the dispersing operation of the process of the invention has no special features, but can instead be carried out with the aid of the typical and known mixing methods and mixing assemblies, such as stirred tanks, dissolvers, stirrer mills, compounders, static mixers or extruders.

The resulting mixture can likewise be homogenized with the aid of the typical and known homogenizing methods and homogenizers, such as stirrers or dissolvers, for example.

With particular preference the coating materials of the invention are used as solid-color topcoat materials for producing one-coat solid-color topcoats, or as aqueous basecoat materials for producing multicoat color and/or effect paint systems. With very particular preference they are used as aqueous basecoat materials for producing color and/or effect basecoats of multicoat paint systems, preferably multicoat paint systems for automobile bodies or parts thereof. In this context they are outstandingly suitable for OEM finishing and for refinish.

With very particular preference the multicoat paint systems of the invention are produced by wet-on-wet methods in which
(1) at least one aqueous basecoat material is applied to a primed or unprimed substrate to give at least one aqueous basecoat film (1),
(2) at least one clearcoat material is applied to the aqueous basecoat film(s) (1) to give at least one clearcoat film (2), and
(3) at least the aqueous basecoat film(s) (1) and the clearcoat film(s) (2) are jointly cured to give the basecoat (1) and the clearcoat (2).

Examples of such wet-on-wet methods are known from
German patent application DE 199 48 004 A1, page 17 line 37 to page 19 line 22, or
German patent DE 100 43 405 C1, column 3, paragraph [0019], and column 8, paragraph [0052] to column 9, paragraph [0057], in conjunction with column 6, paragraph [0039] to column 8, paragraph [0050].

The film thicknesses described therein can be employed for the individual coats of the multicoat paint system of the invention.

The invention is illustrated below by examples.

### EXAMPLES

### Preparation Example 1

### The Preparation of a Gray Aqueous Basecoat Material 1

For better assessment of any paint defects occurring, a gray aqueous basecoat material was used that was prepared in accordance with the following instructions.

### Mixture 1a:

A dissolver was charged with 26 parts by weight of a dispersion of an inorganic thickener (sodium magnesium phyllosilicate, 3% by weight in water). Added to this initial charge with stirring were 30 parts by weight of deionized water, 107.5 parts by weight of butylglycol, 4.5 parts by weight of a polyurethane-modified polyacrylate prepared according to page 7 line 55 to page 8 line 23 of German patent application DE 44 37 535 A1, and 0.6 part by weight of a 20.5% strength by weight solution of a commercial defoamer (Nopco® DSX 1550 from Cognis). This gave the mixture 1a.

### Mixture 1b:

Separately, 3.2 parts by weight of an aqueous polyester resin dispersion prepared according to Example D, column 16 lines 37 to 59, of German patent application DE 40 09 858 A1, 0.3 part by weight of a surfactant solution containing 52% by weight of Surfynol® 104 from Air Products, 55 parts by weight of butylglycol, 4.1 parts by weight of a commercial, water-dilutable melamine-formaldehyde resin in n-butanol (Cymel® 203 from Surface Specialties Austria), and 0.3 part by weight of a 10% strength by weight solution of dimethylethanolamine in water were mixed together. This gave the mixture 1b.

### Mixture 1c:

Mixtures 1a and 1b were mixed together. This gave the mixture 1c.

### Mixture 1d:

Mixture 1c was admixed with 6 parts by weight of deionized water, 20.4 parts by weight of an acrylated polyurethane prepared according to page 19 line 44 to page 20 line 7 of German patent application DE 199 48 004 A1, 1.6 parts by weight of a surfactant solution containing 52% by weight of Surfynol® 104 from Air Products, 48 parts by weight of butoxyethanol, 0.4 part by weight of a 10% strength by weight solution of dimethylethanolamine in water, 1.6 parts by weight of n-butanol and 3.9 parts by weight of a 3% by strength by weight solution of a polyacrylate thickener (Viscalex® from Ciba). This gave the mixture 1d.

### Carbon Black Paste:

The carbon black paste was prepared by mixing from 25 parts by weight of a polyacrylate dispersion prepared according to international patent application WO 91/15528 (page 23 line 29 to page 24 line 24), 10 parts by weight of carbon black, 0.1 part by weight of methyl isobutyl ketone, 1.36 parts by weight of dimethylethanolamine, 2 parts by weight of a commercial polyether (Pluriol® P900 from BASF Aktiengesellschaft), and 61.45 parts by weight of deionized water.

### Blue Paste:

The blue paste was prepared by mixing from 19.4 parts by weight of a polyurethane dispersion prepared according to column 16 lines 10 to 35 of German patent application DE 40 09 858 A1, 13.5 parts by weight of Paliogen® Blau L 6482 from BASF AG, 4.3 parts by weight of butoxyethanol, 0.18 part by weight of methyl ethyl ketone, 0.62 part by weight of dimethylethanolamine, 1.2 parts by weight of Pluriol® P900 from BASF AG, and 61 parts by weight of water.

### Paste Mixture:

The paste mixture was prepared from 0.5 part by weight of the carbon black paste, 0.1 part by weight of the blue paste, and 0.5 part by weight of a paste prepared according to section 9 of German patent application DE 100 04 494 A1.

### Mixture 1e:

Mixture 1e was prepared by mixing all of the paste mixture and all of mixture 1d.

### Aluminum Effect Pigment Paste:

The aluminum effect pigment paste was prepared from 3.2 parts by weight of a first 65% by weight pasted aluminum effect pigment (Alu-Stapa-Hydrolux® 2153 from Eckart) and 3.2 parts of a second 65% by weight pasted aluminum effect pigment (Alu-Starter-Hydrolux 8154 from Eckart), 7.5 parts by weight of butylglycol, and 5.0 parts by weight of the aqueous polyester resin dispersion prepared according to Example D, column 16 lines 37 to 59, of German patent application DE 40 09 858 A1.

### Aqueous Basecoat Material 1:

Aqueous basecoat material 1 was prepared by mixing all of mixture 1e, all of the aluminum effect pigment paste, and two parts by weight of water. It was subsequently adjusted with dimethylethanolamine to a pH of 8 and with deionized water to a viscosity of 58 mPas under a shearing load of 1000/second, measured with a rotary viscometer (Rheomat RM 180 instrument from Mettler-Toledo) at 23° C.

### Aqueous Basecoat Material I2:

The inventive aqueous basecoat material I2 was prepared by admixing aqueous basecoat material 1 with the commercially available polytetrahydrofuran PolyTHF 1800® (BASF AG), in the proportion indicated in table 1.

### Aqueous Basecoat Material I3:

The inventive aqueous basecoat material I2 was prepared by admixing aqueous basecoat material 1 with the commercially available polytetrahydrofuran PolyTHF 2000® (BASF AG), in the proportion indicated in table 1.

TABLE 1
Composition of aqueous basecoat materials (ABM) 1,
I2 and I3

| ABM | ABM 1 [% by weight] | PolyTHF | [% by weight] |
|---|---|---|---|
| 1 | 100 | — | — |
| I2 | 98 | PolyTHF 1800 ® | 2.0 |
| I3 | 98 | PolyTHF 2000 ® | 2.0 |

The weight percent figures of table 1 are based on the total weight of the respective coating material.

For determination of the grind mark concealment capacity, multicoat paint systems were produced with the aqueous basecoat materials 1, I2 and I3, in accordance with the following general instructions:

A metal coil panel measuring 30×60 cm was coated with a primer-surfacer, and the primer-surfacer was baked at 160° C. for a time of 20 minutes. Atop this panel a grinding cross was applied by means of an abrasive paper possessing 800 particles per cm² on the surface, the grinding cross having a depth of 2-4 μm and a furrow width of 2 cm. Then the corresponding basecoat material was applied, with a film thickness of 8-12 μm. Subsequently the resulting panel was dried at 80° C. for 10 minutes, and the dried aqueous basecoat film had a typical and known two-component clearcoat material applied over it. Subsequently, the aqueous basecoat film and clearcoat film were cured jointly in a forced-air oven at 140° C. for 20 minutes.

The visibility of the grinding cross in the multicoat paint system was determined visually and assessed on a scale from 1 to 5. On this scale, high numerical values indicate high visibility of the grinding cross, and low numerical values indicate effective concealment of the grinding crosses. An assessment was also made of whether the visibility of the grind marks would have necessitated recoating (“not OK”) or not (“OK”). Table 2 gives an overview of the experimental results.

TABLE 2
Visibility of the grinding crosses in the multicoat paint
systems

| ABM used | Visibility of grinding cross | Assessment |
|---|---|---|
| I1 | 3 | not OK |
| I2 | 2-3 | OK |
| I3 | 2 | OK |

The experimental results in table 2 underline the fact that the addition of polytetrahydrofuran has a reducing or preventive effect on the visibility of grind marks.

### Preparation Example 2

### The Preparation of a Silver Aqueous Basecoat Material 2

For better assessment of any paint defects occurring, a silver aqueous basecoat material was used that was prepared in accordance with the following instructions.

Mixture 2a:

A dissolver was charged with 29.5 parts by weight of a dispersion of an inorganic thickener (sodium magnesium phyllosilicate, 3% by weight in water). Added to this initial charge with stirring were 30 parts by weight of an aqueous polyurethane dispersion prepared according to column 16 lines 10 to 35 of DE 4009858-A1. This gave the mixture 2a.

### Mixture 2b:

Separately, 5.7 parts by weight of a commercial, water-dilutable melamine-formaldehyde resin in n-butanol (Cymel® 327 from Surface Specialties Austria), 1.1 parts by weight of butylglycol, and 1.6 parts by weight of a surfactant solution containing 52% by weight of Surfynol® 104 from Air Products were mixed. This gave the mixture 2b.

### Mixture 2c:

Mixtures 2a and 2b were mixed together. This gave the mixture 2c.

### Mixture 2d:

Mixture 2c was mixed with 0.9 part by weight of a commercial polyether (Pluriol® P900 from BASF Aktiengesellschaft), 2.4 parts by weight of commercial isopropanol, 0.6 part by weight of commercial 2-ethylhexanol, and 2.1 parts by weight of a polyurethane-modified polyacrylate prepared according to page 7 line 55 to page 8 line 23 in DE 4437535-A1. This gave the mixture 2d.

### Carbon Black Paste:

The carbon black paste was prepared by mixing from 25 parts by weight of a polyacrylate dispersion prepared according to international patent application WO 91/15528 (page 23 line 29 to page 24 line 24), 10 parts by weight of carbon black, 0.1 part by weight of methyl isobutyl ketone, 1.36 parts by weight of dimethylethanolamine, 2 parts by weight of a commercial polyether (Pluriol® P900 from BASF Aktiengesellschaft), and 61.45 parts by weight of deionized water.

### Blue Paste:

The blue paste was prepared by mixing from 19.4 parts by weight of a polyurethane dispersion prepared according to column 16 lines 10 to 35 of German patent application DE 40 09 858 A1, 13.5 parts by weight of Paliogen® Blau L 6482 from BASF AG, 4.3 parts by weight of butoxyethanol, 0.18 part by weight of methyl ethyl ketone, 0.62 part by weight of dimethylethanolamine, 1.2 parts by weight of Pluriol® P900 from BASF AG, and 61 parts by weight of water.

### Paste Mixture:

The paste mixture was prepared from 1.2 parts by weight of the carbon black paste, 1.1 parts by weight of the blue paste, and 1.0 part by weight of a paste prepared according to section 9 of German patent application DE 100 04 494 A1.

### Aluminum Effect Pigment Paste:

The aluminum effect pigment paste was prepared from 3.3 parts by weight of a first 65% by weight pasted aluminum effect pigment (Alu-Stapa-Hydrolux® 2192 from Eckart), 4 parts by weight of butylglycol, 4 parts by weight of the aqueous polyester resin dispersion prepared according to Example D, column 16 lines 37 to 59, of German patent application DE 40 09 858 A1, and 0.5 part by weight of a 10% strength by weight solution of dimethylethanolamine in water.

Using these constituents, the aqueous basecoat material 2 (via mixture 2e) and the inventive aqueous basecoat material I4 (via mixture I4e) were prepared as follows.

### Mixture 2e:

Mixture 2e was prepared by mixing all of the paste mixture, all of mixture 2d, 1.3 parts by weight of deionized water, and 5.1 parts by weight of an aqueous polyester resin dispersion prepared according to example D, column 16 lines 37 to 59, of German patent application DE 40 09 858 A1, 2 parts by weight of commercial butoxyethanol, and 0.7 part by weight of a 10% strength by weight solution of dimethylethanolamine in water.

### Aqueous Basecoat Material 2:

Aqueous basecoat material 2 was prepared by mixing all of mixture 2e, all of the aluminum effect pigment paste, and 1.6 parts by weight of water. It was subsequently adjusted with dimethylethanolamine to a pH of 8 and with deionized water to a viscosity of 65 mPas under a shearing load of 1000/second, measured with a rotary viscometer (Rheomat RM 180 instrument from Mettler-Toledo) at 23° C.

### Mixture I4e:

Mixture I4e was prepared by mixing all of the paste mixture, all of mixture 2d, 1.3 parts by weight of deionized water, and 15 parts by weight of a commercially available polytetrahydrofuran PolyTHF 2000®(BASF AG), 2 parts by weight of commercial butoxyethanol, and 0.7 part by weight of a 10% strength by weight solution of dimethylethanolamine in water.

### Aqueous Basecoat Material I4:

Aqueous basecoat material I4 was prepared by mixing all of the mixture I4e, all of the aluminum effect pigment paste, and 1.6 parts by weight of water. It was subsequently adjusted with dimethylethanolamine to a pH of 8 and with deionized water to a viscosity of 65 mPas under a shearing load of 1000/second, measured with a rotary viscometer (Rheomat RM 180 instrument from Mettler-Toledo) at 23° C.

TABLE 3
Composition of aqueous basecoat materials (ABM) 2
and I4

| ABM | ABM [% by weight] | PolyTHF | [% by weight] |
|---|---|---|---|
| 2 | 100 | — | — |
| I4 | 86.3 | PolyTHF 2000 ® | 13.7 |

The weight percent figures of table 3 are based on the total weight of the respective coating material.

For determination of the grind mark concealment capacity, multicoat paint systems were produced with the aqueous basecoat materials 2 and I4, in accordance with the following general instructions:

A metal coil panel measuring 30×60 cm was coated with a primer-surfacer, and the primer-surfacer was baked at 160° C. for a time of 20 minutes. Atop this panel a grinding cross was applied by means of an abrasive paper possessing 800 particles per cm² on the surface, the grinding cross having a depth of 2-4 μm and a furrow width of 2 cm. Then the corresponding basecoat material was applied, with a film thickness of 8-12 μm. Subsequently the resulting panel was dried at 80° C. for 10 minutes, and the dried aqueous basecoat film had a typical and known two-component clearcoat material applied over it. Subsequently, the aqueous basecoat film and clearcoat film were cured jointly in a forced-air oven at 140° C. for 20 minutes.

The visibility of the grinding cross in the multicoat paint system was determined visually and assessed on a scale from 1 to 5. On this scale, high numerical values indicate high visibility of the grinding cross, and low numerical values indicate effective concealment of the grinding crosses. An assessment was also made of whether the visibility of the grind marks would have necessitated recoating (“not OK”) or not (“OK”). Table 4 gives an overview of the experimental results.

TABLE 4
Visibility of the grinding crosses in the multicoat paint
systems

| ABM used | Visibility of grinding cross | Assessment |
|---|---|---|
| 2 | 4 | not OK |
| I4 | 3 | OK |

The experimental results in table 4 underline the fact that the addition of polytetrahydrofuran has a reducing or preventive effect on the visibility of grind marks.

1. An aqueous coating material comprising at least one polyurethane that is stabilized with at least one of ionically, nonionically, or a combination thereof, and which is at least one of saturated, unsaturated, grafted with olefinically unsaturated compounds, or a combination thereof, wherein said coating material comprises from between 0.5% and 30% by weight of polytetrahydrofuran, based on the total weight of the coating material.

2. The aqueous coating material of claim 1, comprising from between 0.5% and 20% by weight of polytetrahydrofuran, based on the total weight of the coating material.

3. The aqueous coating material of claim 2, comprising from between 1% and 15% by weight of polytetrahydrofuran, based on the total weight of the coating material.

4. The aqueous coating material of claim 1 wherein the polytetrahydrofuran comprises a number-average molar mass of 250 to 10 000.

5. The aqueous coating material claim 4, wherein the polytetrahydrofuran a number-average molar mass of 250 to 2000.

6. The aqueous coating material claim 1, further comprising at least one additive selected from the group consisting of salts which can be decomposed thermally without residue or substantially without residue, binders other than the polyurethanes, and which are curable physically, thermally and/or with actinic radiation, crosslinking agents, organic solvents, thermally curable reactive diluents, reactive diluents curable with actinic radiation, color and/or effect pigments, transparent pigments, fillers, molecularly dispersely soluble dyes, nanoparticles, light stabilizers, antioxidants, devolatilizers, emulsifiers, slip additives, polymerization inhibitors, free-radical polymerization initiators, thermolabile free-radical initiators, adhesion promoters, flow control agents, film-forming assistants, thickeners, rheological assistants, flame retardants, corrosion inhibitors, free-flow aids, waxes, siccatives, biocides, and matting agents.

7. The aqueous coating material of claim 6, further comprising at least two additives selected from the group consisting of salts which can be decomposed thermally without residue or substantially without residue, binders other than the polyurethanes and which are curable physically, thermally and/or with actinic radiation, crosslinking agents, organic solvents, thermally curable reactive diluents, reactive diluents curable with actinic radiation, color and/or effect pigments, transparent pigments, fillers, molecularly dispersely soluble dyes, nanoparticles, light stabilizers, antioxidants, devolatilizers, emulsifiers, slip additives, polymerization inhibitors, free-radical polymerization initiators, thermolabile free-radical initiators, adhesion promoters, flow control agents, film-forming assistants, thickeners, rheological assistants, flame retardants, corrosion inhibitors, free-flow aids, waxes, siccatives, biocides, and matting agents.

8. The aqueous coating material of claim 1, comprising a solids content of 5% to 70% by weight, based on the total weight of the coating material.

9. The aqueous coating material of claim 8, comprising a solids content of 10% to 65% by weight, based on the total weight of the coating material.

10. The aqueous coating material of claim 9, comprising a solids content of 15% to 60% by weight, based on the total weight of the coating material.

11. A process for preparing the aqueous coating material as of claim 1, which comprising dispersing the at least one ionically and/or nonionically stabilized polyurethane which is saturated, unsaturated and/or grafted with olefinically unsaturated compounds, and between 0.5% and 30% by weight of polytetrahydrofuran, based on the total weight of the coating material, in an aqueous medium.

12. The process of claim 11, further comprising adding at least one wetting agent or dispersant prior to said dispersing.

13. The process of claim 11, wherein the resulting dispersion is then homogenized.

14. A process of coating a substrate, comprising applying the aqueous coating material of claim 1 to a substrate, wherein the aqueous coating material is an aqueous basecoat material for producing a multicoat color and/or effect paint system.

15. The process of claim 14, wherein the multicoat color and/or effect paint system is produced by a wet-on-wet method.

16. The process of claim 14, wherein the substrate is at least one of an automobile body or part thereof.
